(19) United States
(12) Patent Application Publication
(10) Pub. No.: US 2025/0350863 A1
(43) Pub. Date: Nov. 13, 2025

(54) IMAGE PICKUP APPARATUS, ITS CONTROL METHOD, AND STORAGE MEDIUM

(71) Applicant: CANON KABUSHIKI KAISHA, Tokyo (JP)

(72) Inventor: HIROTARO KIKUCHI, Tokyo (JP)

(21) Appl. No.: 19/096,893

(22) Filed: Apr. 1, 2025

(30) Foreign Application Priority Data
May 7, 2024 (JP) 2024-075326

(51) Int. Cl. H04N 25/705; H04N 25/704

(52) U.S. Cl. CPC H04N 25/705; H04N 25/704

(57) ABSTRACT

An image pickup apparatus includes an image sensor, and a processor configured to acquire a focus detection amount based on a signal acquired from the image sensor, control an aperture stop based on the focus detection amount, and determine an aperture value such that a plurality of objects or a plurality of parts fall within a predetermined depth within a range that satisfies a predetermined condition that enables focus detection.

### BACKGROUND

### Technical Field

The present disclosure relates to an image pickup apparatus, its control method, and a storage medium.

### Description of Related Art

In digital cameras using an image sensor, autofocus (AF) processing has conventionally been known, which detects an object or an object part in an image obtained from an image sensor, calculates a focus detection amount from a signal of the detected object or object part, and performs focusing. Simultaneous focusing on a plurality of objects or object parts is also demanded. Japanese Patent Application Laid-Open No. 2003-131115 discloses a method of controlling an aperture stop in an imaging optical system and performing depth control such that a plurality of objects fall within the depth of field.

In a case where the aperture is narrowed down by the depth control, it is to increase the ISO speed to obtain proper exposure, and noise in the signal obtained from the image sensor increases. As a result, the variation in the focus detection amount increases and the AF accuracy decreases, so depending on the imaging condition, AF processing may become impossible (AF inability).

The method disclosed in Japanese Patent Application Laid-Open No. 2003-131115 sets an upper limit for the ISO speed during the depth control to suppress noises, and determines the aperture to achieve proper exposure. However, whether AF is possible or not is determined not only by noise but also by a combination of an object condition (contrast) and an imaging condition (base length, accumulation time, etc.) of the image pickup apparatus. Therefore, the method disclosed in Japanese Patent Application Laid-Open No. 2003-131115 performs the depth control only based on noise and thus has difficulty in preventing the AF inability.

### SUMMARY

An image pickup apparatus according to one aspect of the disclosure includes an image sensor, and a processor configured to acquire a focus detection amount based on a signal acquired from the image sensor, control an aperture stop based on the focus detection amount, and determine an aperture value such that a plurality of objects or a plurality of parts fall within a predetermined depth within a range that satisfies a predetermined condition that enables focus detection. A control method of the above image pickup apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an imaging system according to each embodiment.

FIG. 2 is a block diagram of the imaging system according to each embodiment.

FIG. 3 is a schematic diagram of a pixel array according to each embodiment.

FIGS. 4A and 4B are schematic diagrams of pixel structures according to each embodiment.

FIG. 5 explains an image sensor and a pupil dividing function according to each embodiment.

FIG. 6 explains the image sensor and the pupil dividing function according to each embodiment.

FIG. 7 illustrates a relationship between a defocus amount and an image shift amount in each embodiment.

FIGS. 8A and 8B explain a relationship between an aperture value (F-number) and a base length in each embodiment.

FIGS. 9A and 9B explain a relationship between a focus-detecting image height and a base length in each embodiment.

FIG. 10 is a flowchart illustrating focus detecting processing according to each embodiment.

FIG. 11 explains an AF area that is used in focus detecting processing by phase difference according to each embodiment.

FIGS. 12A, 12B, and 12C illustrate a pair of image signals acquired from the AF area according to each embodiment.

FIGS. 13A and 13B illustrate a relationship between the shift amount and correlation amount of a pair of image signals in each embodiment.

FIGS. 14A and 14B illustrate a relationship between the shift amount and correlation change amount of a pair of image signals in each embodiment.

FIGS. 15A and 15B illustrate a relationship between the steepness degree of the correlation change amount and the standard deviation of the image shift amount in each embodiment.

FIG. 16 illustrates a relationship between the steepness degree of the correlation change amount and the standard deviation of the image shift amount at low ISO speed and high ISO speed in each embodiment.

FIG. 17 illustrates a state in which a primary object and a secondary object have been detected according to each embodiment.

FIG. 18 is a flowchart illustrating a depth control method in a first embodiment.

FIG. 19 illustrates a correspondence example between exposure and AF reliability from current aperture value Fpre to target aperture value Fobj according to each embodiment.

FIG. 20 is a flowchart illustrating a depth control method according to a second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of the embodiments according to the present disclosure. In each embodiment, an electronic apparatus will be described as a digital camera (image pickup apparatus), but this embodiment is not limited to this example. Each embodiment can be applied to an arbitrary electronic apparatus having an image pickup apparatus, such as a focus detecting apparatus, a distance detecting apparatus, an information processing apparatus, a mobile phone, a personal computer, or a game machine.

### First Embodiment

### Overall Configuration

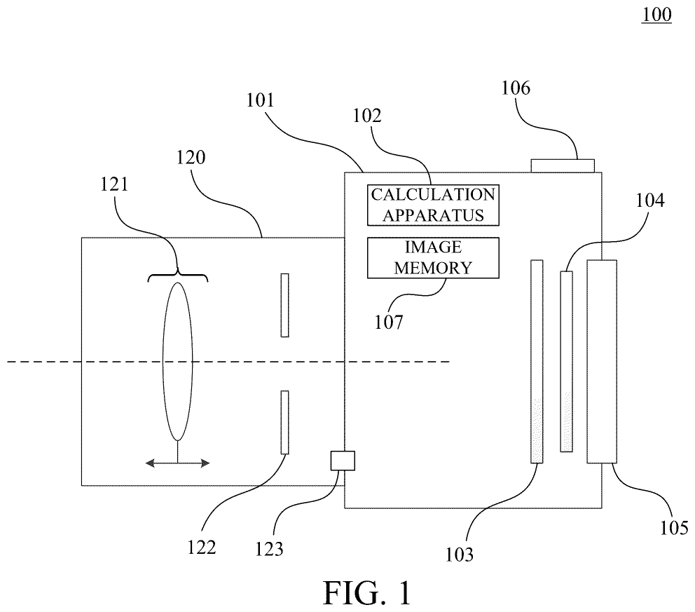

Referring now to FIG. 1, a description will be given of an imaging system (digital single-lens camera system) 100 according to a first embodiment. FIG. 1 is a sectional view illustrating the configuration of the imaging system 100.

The imaging system 100 includes a camera body (image pickup apparatus) 101 and a lens unit (lens apparatus) 120 attachable to and detachable from the camera body 101. As illustrated in FIG. 1, the imaging system 100 has the interchangeable lens unit 120 attachable to and detachable from the front side (object side) of the camera body 101. The lens unit 120 includes a focus lens 121 and an aperture stop (diaphragm) 122, etc., and is electrically connected to the camera body 101 via a mount contact portion 123. Thereby, a light amount taken into the camera body 101 and a focus position can be adjusted. The focus lens 121 can also be adjusted manually by the user.

An image sensor 104 includes a Charge Coupled Device (CCD) sensor, a Complementary Metal-Oxide-Semiconductor (CMOS) sensor, etc., and includes an infrared cut filter and a low-pass filter, etc. In capturing an image, the image sensor 104 photoelectrically converts an object image formed by passing through the imaging optical system of the lens unit 120, and transmits a signal for generating a captured image to a calculation apparatus 102. The calculation apparatus 102 generates the captured image from the received signal, stores the image in the image memory 107, and displays it on the display unit 105, such as an LCD. A shutter 103 blocks light from the image sensor 104 during non-imaging, and opens to expose the image sensor 104 to light during imaging.

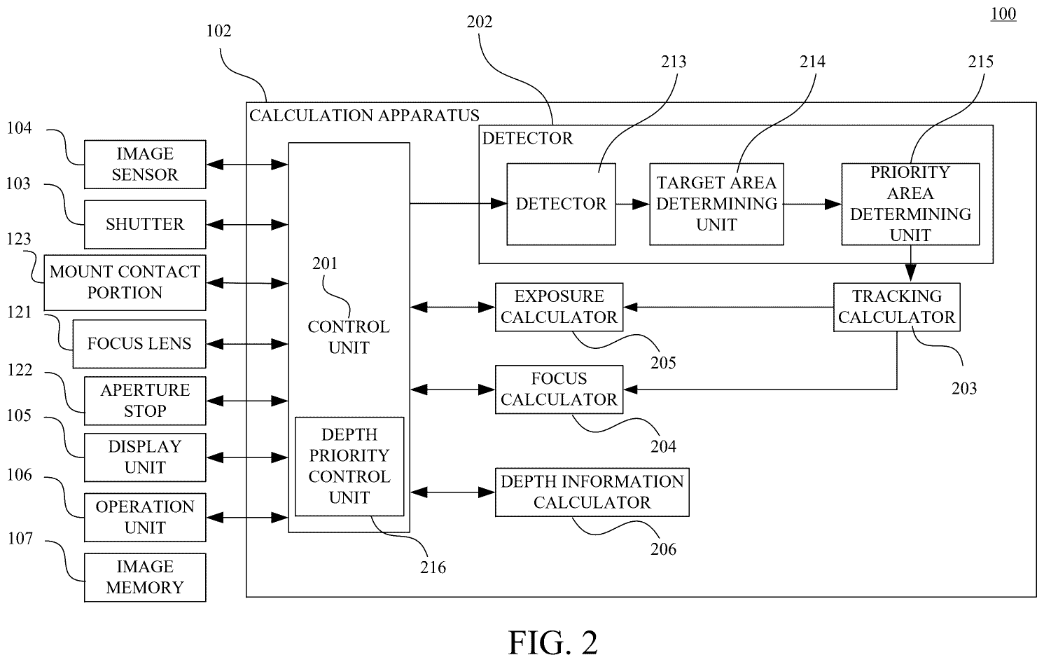

Referring now to FIG. 2, the configuration regarding the control of the imaging system 100 will be described. FIG. 2 is a block diagram illustrating the electrical configuration of the imaging system 100.

The calculation apparatus 102 includes a multi-core CPU capable of parallel processing of a plurality of tasks, a Random Access Memory (RAM), and a Read Only Memory (ROM), as well as a dedicated circuit for executing specific calculation processing at high speed. Due to these hardware components, the calculation apparatus 102 includes a control unit 201, a detector 202, a tracking calculator 203, a focus calculator (focus detector) 204, and an exposure calculator 205. The control unit 201 controls each part of the camera body 101 and the lens unit 120. For example, the control unit 201 controls the aperture stop 122 based on the focus detection amount calculated by the focus calculator 204.

The detector 202 includes three components: a detector 213, a target area determination unit 214, and a priority area determination unit 215. The detector 213 performs processing to detect a specific area, such as a human face or pupils, or an animal's face or pupils, from an image. No specific area may be detected, or a plurality of specific areas may be detected. A detector for the pupils of a human or animal is included in the detector 213. An arbitrary known method such as AdaBoost or a convolutional neural network may be used as a detection method. The implementation form may be a program running on a CPU, dedicated hardware, or a combination of them.

The object detection result obtained from the detector 213 is sent to the target area determination unit 214, which selects one or more objects such as a person and object parts such as pupils that have been detected, and determines them as target areas to be used for depth priority control, which will be described later. The target area is determined using a known calculation method based on the type, size, and position of the detected object and object part, the reliability of the detection result, and the like. In addition to objects such as people and object parts such as eyes detected by the detector 213, the target area may be determined based on the past detection result, a feature amount such as an edge of the target frame, defocus information about an object, and the like.

The priority area determination unit 215 determines the priority of each of the target areas determined by the target area determination unit 214. Regarding the priority, only the target area with the highest priority may be determined, or each of the target areas may be prioritized.

The tracking calculator 203 performs tracking processing of the target area based on the detection information about the target area. The tracking method can use a known method such as template matching that compares feature amounts between frames. The focus calculator 204 is a focus detector that obtains a focus detection amount (defocus information, defocus amount) based on a signal (focus detecting signal) obtained from the image sensor 104. The focus calculator 204 obtains defocus information for focusing and calculates a control value for the focus lens 121.

The exposure calculator 205 calculates control values for the aperture stop 122, the image sensor 104, the shutter 103, and the like to properly expose the primary object area. A specific calculation example of the control value will be given. In controlling the aperture stop 122 to a smaller value, an amplification amount (gain amount) of the signal for generating the captured image obtained by the image sensor 104 is reduced in order to properly control the exposure, and the opening time of the shutter 103 is reduced (the shutter speed is increased). In controlling the aperture stop 122 to a larger value, the gain amount is increased and the shutter speed is reduced in order to properly control the exposure.

The depth information calculator 206 acquires defocus information and calculates depth information corresponding to a distance in the depth direction from the camera body 101 (or the imaging system 100) to the object. The position in the depth direction of the object acquired based on the calculated depth information will be referred to as a “depth position,” and a difference in the distance in the depth direction of a plurality of objects will be referred to as a “depth difference.” In this embodiment, the depth information is calculated using the difference in the defocus amount calculated by the phase-difference detecting method, but the depth information may be acquired using a depth sensor such as a LiDAR sensor that obtains depth information using laser beam reflection. An arbitrary known method may be used to obtain the depth information.

Next, the control unit 201 controls the focus lens 121, the aperture stop 122, the display unit 105, etc. based on the results of the detector 202, the exposure calculator 205, and the focus calculator 204. The control unit 201 includes a depth priority control unit 216. In a case where a plurality of target areas (a plurality of objects or a plurality of parts, etc.) are set by the detector 202, the depth priority control unit 216 determines whether the plurality of target areas can fall within a specific depth (within a specified depth) using the depth information calculated by the depth information calculator 206.

In a case where the plurality of target areas can fall within the specific depth, the depth priority control unit 216 calculates control values for the focus lens 121 and the aperture stop 122. The depth priority control unit 216 controls the focus lens 121 and the aperture stop 122 based on the calculated control values. The display unit 105 receives the control result and displays a frame on the display screen indicating whether the object is in focus or not. The specific depth generally refers to a depth of field, but may be any depth that is set arbitrarily. An object that falls within the specific depth (depth of field) is defined as being in focus.

The operation unit 106 includes a release switch, a mode dial, and the like. The control unit 201 can receive an imaging instruction or a mode switch instruction from the user through the operation unit 106. The above is the configuration of the imaging system 100 according to this embodiment.

### Image Sensor

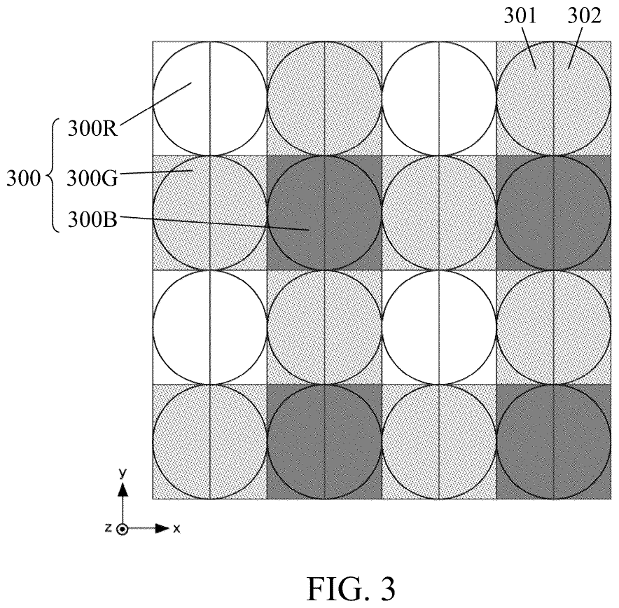

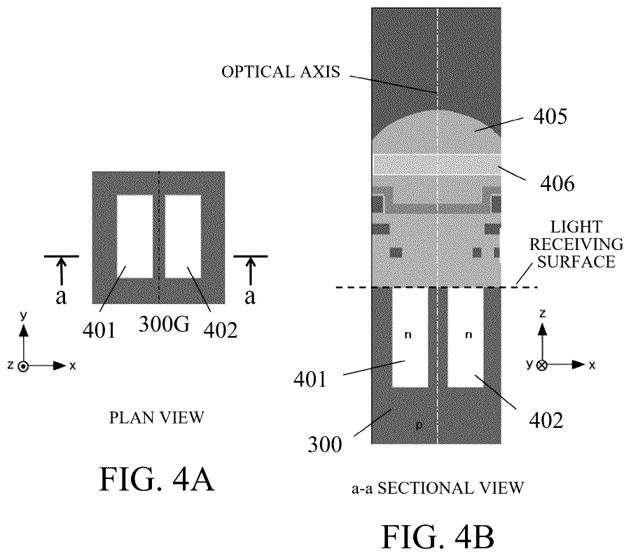

Referring now to FIGS. 3, 4A, and 4B, a description will be given of the pixel array and pixel structure of the image sensor 104 in this embodiment. FIG. 3 is a schematic diagram of the pixel array of the image sensor 104. FIGS. 4A and 4B are schematic diagrams of the pixel structure of the image sensor 104. FIG. 4A illustrates a plan view (viewed from the +z direction) of pixel 300G of the image sensor 104, and FIG. 4B illustrates a sectional view (viewed from the −y direction) of a line a-a in FIG. 4A.

FIG. 3 illustrates the pixel array (arrangement of imaging pixels) of the image sensor (two-dimensional CMOS sensor) 104 in an area of 4 columns×4 rows. In this embodiment, each imaging pixel (pixels 300R, 300G, 300B) includes two subpixels (focus detecting pixels) 301 and 302. Thus, the subpixel array is illustrated in an area of 8 columns×4 rows in FIG. 3.

As illustrated in FIG. 3, in the 2 columns×2 rows pixel group 300, the pixels 300R, 300G, and 300B are arranged in a Bayer array. That is, among the pixel group 300, the pixel 300R having a spectral sensitivity of R (red) is disposed at the upper left, the pixel 300G having a spectral sensitivity of G (green) is disposed at the upper right and lower left, and the pixel 300B having a spectral sensitivity of B (blue) is disposed at the lower right. Each of the pixels 300R, 300G, and 300B (each imaging pixel) includes a subpixel (first focus detecting pixel) 301 and a subpixel (second focus detecting pixel) 302 disposed in 2 columns×1 row. The subpixel 301 is a pixel that receives a light beam that has passed through a first partial pupil region of the imaging optical system. The subpixel 302 is a pixel that receives a light beam that has passed through a second partial pupil region of the imaging optical system. The subpixels 301 constitute a first pixel group, and the subpixels 302 constitute a second pixel group. The image sensor 104 is configured by arranging a plurality of imaging pixels (subpixels of 8 columns×4 rows) in 4 columns×4 rows on a surface, and outputs an imaging signal (subpixel signal or focus detecting signal).

As illustrated in FIG. 4B, the pixel 300G in this embodiment includes a microlens 405 for condensing incident light on the light receiving surface side of the pixels. A plurality of microlenses 405 are two-dimensionally arranged, and are disposed at a position a predetermined distance away from the light receiving surface in the z-axis direction (direction of the optical axis OA). The pixel 300G also has the photoelectric converters 401 and 402 that are NH-divided (divided into two) in the x direction and Nv-divided (divided into one) in the y direction. The photoelectric converters 401 and 402 correspond to the subpixels 301 and 302, respectively. Thus, the image sensor 104 has a plurality of photoelectric converters for a single microlens, and the microlenses are arranged two-dimensionally. Each of the photoelectric converters 401 and 402 includes a photodiode having a pin structure in which an intrinsic layer is sandwiched between a p-type layer and an n-type layer. If necessary, the intrinsic layer may be omitted and the photoelectric converter may be configured as a pn junction photodiode.

In the pixel 300G (each pixel), a G (green) color filter 406 is provided between the microlens 405 and the photoelectric converters 401 and 402. Similarly, in the pixels 300R and 300B (each pixel), R (red) and B (blue) color filters 406 are provided between the microlens 405 and the photoelectric converters 401 and 402. If necessary, the spectral transmittance of the color filter 406 can be changed for each subpixel, or the color filter may be omitted.

In FIGS. 4A and 4B, light incident on the pixel 300G (300R, 300B) is condensed by the microlens 405, dispersed by the G color filter 406 (R and B color filters 406), and then received by the photoelectric converters 401 and 402. In the photoelectric converters 401 and 402, pairs of electrons and holes are generated according to the received light amount. After they are separated by a depletion layer, the negatively charged electrons are accumulated in the n-type layer. The holes are discharged to the outside of the image sensor 104 through a p-type layer connected to a constant voltage source (not illustrated). The electrons accumulated in the n-type layers of the photoelectric converters 401 and 402 are transferred to a capacitance unit (FD) through a transfer gate and converted into a voltage signal.

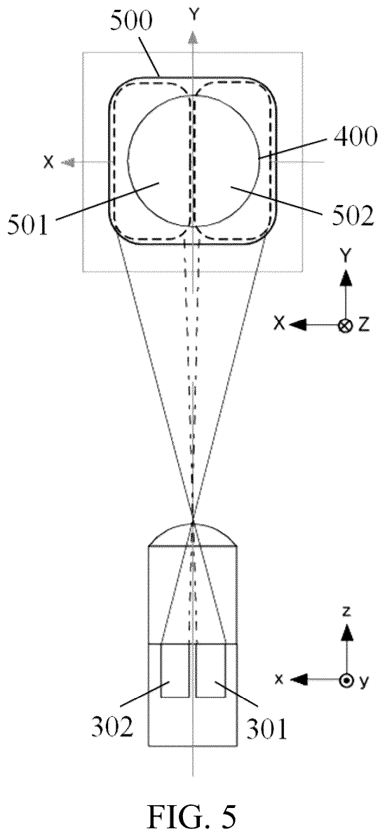

Referring now to FIG. 5, a description will be given of the pupil dividing function of the image sensor 104. FIG. 5 explains the pupil dividing function of the image sensor 104, and illustrates the state of pupil division in one pixel unit. FIG. 5 illustrates a sectional view of the a-a section of the pixel structure illustrated in FIG. 4A viewed from the +y side, and the exit pupil plane of the imaging optical system. In FIG. 5, the x-axis and y-axis of the sectional view are inverted with respect to the x-axis and y-axis of FIGS. 4A and 4B, respectively, to correspond to the coordinate axes of the exit pupil plane.

In FIG. 5, a partial pupil region (first partial pupil region) 501 of a subpixel (first focus detecting pixel) 301 is in an approximately conjugate relationship via the microlens 405 with the light receiving surface of the photoelectric converter 401 whose center of gravity is decentered in the −x direction. Therefore, the partial pupil region 501 represents a pupil region that can receive light by the subpixel 301. The center of gravity of the partial pupil region 501 of the subpixel 301 is decentered on the +X side on the pupil plane. A partial pupil region (second partial pupil region) 502 of a subpixel (second focus detecting pixel) 302 is in an approximately conjugate relationship via the microlens 405 with the light receiving surface of the photoelectric converter 402 whose center of gravity is decentered in the +x direction. Therefore, the partial pupil region 502 represents a pupil region that can receive light by the subpixel 302. The center of gravity of the partial pupil region 502 of the subpixel 302 is decentered on the −X side on the pupil plane. The pupil region 500 is a pupil region that can receive light in the entire pixel 300G in a case where all the photoelectric converters 401 and 402 (subpixels 301 and 302) are combined.

In the image-plane phase-difference AF, the pupil is divided using the microlens 405 of the image sensor 104, so it is affected by diffraction. In FIG. 5, a pupil distance to the exit pupil plane is several tens of mm, while the diameter of the microlens 405 is several μm. Thus, the aperture value of the microlens 405 becomes several tens of thousands, and diffraction blur on the level of several tens of mm occurs. Therefore, the image on the light receiving surface of the photoelectric converters 401 and 402 is not a clear pupil region or partial pupil region, but a pupil intensity distribution (incident angle distribution of light receiving rate).

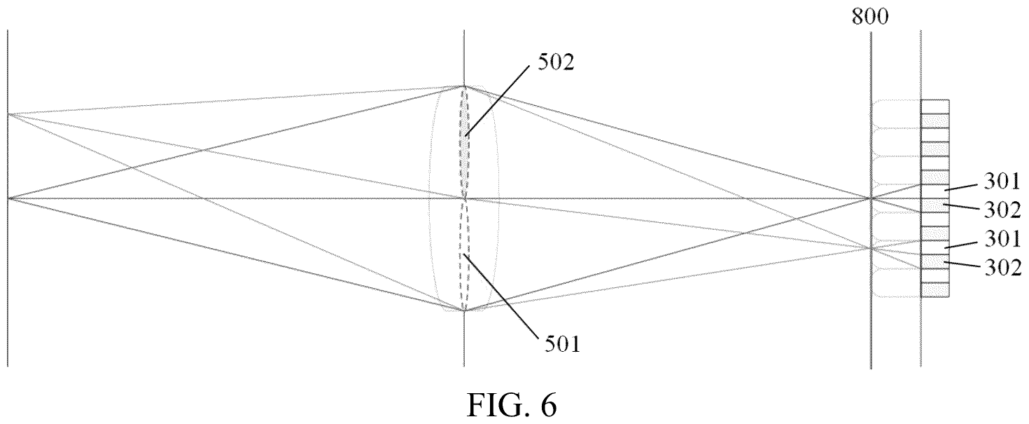

Referring now to FIG. 6, a description will be given of the correspondence between the image sensor 104 and pupil division. FIG. 6 explains the image sensor 104 and the pupil dividing function. The light beams passing through the different partial pupil regions 501 and 502 of the pupil region of the imaging optical system enter the imaging surface 800 of the image sensor 104 at different angles to each pixel of the image sensor 104, and are received by the subpixels 301 and 302 divided into 2×1. In this embodiment, the pupil region is divided into two in the horizontal direction, but this embodiment is not limited to this example, and the pupil may be divided vertically as necessary.

In this embodiment, the image sensor 104 has a first focus detecting pixel configured to receive light beams passing through a first partial pupil region of the imaging optical system (imaging lens), and a second focus detecting pixel configured to receive light beams passing through a second partial pupil region different from the first partial pupil region of the imaging optical system. The image sensor 104 also has an array of imaging pixels that receive light beams passing through a pupil region that is a combination of the first and second partial pupil regions of the imaging optical system. In this embodiment, each imaging pixel (pixel 300) includes a first focus detecting pixel (subpixel 301) and a second focus detecting pixel (subpixel 302). If necessary, the imaging pixel, the first focus detecting pixel, and the second focus detecting pixel may include different pixels. In this case, the first and second focus detecting pixels are partially (discretely) arranged in a part of the imaging pixel array.

In this embodiment, the camera body 101 condenses light reception signals from the first focus detecting pixels (subpixel 301) of each pixel of the image sensor 104 to generate a first focus detecting signal, and condenses light reception signals from the second focus detecting pixels (subpixel 302) of each pixel to generate a second focus detecting signal, thereby performing focus detection. The camera body 101 also generates an imaging signal (captured image) by adding (combining) the signals from the first and second focus detecting pixels for each pixel of the image sensor 104.

### Relationship Between Defocus Amount and Image Shift Amount

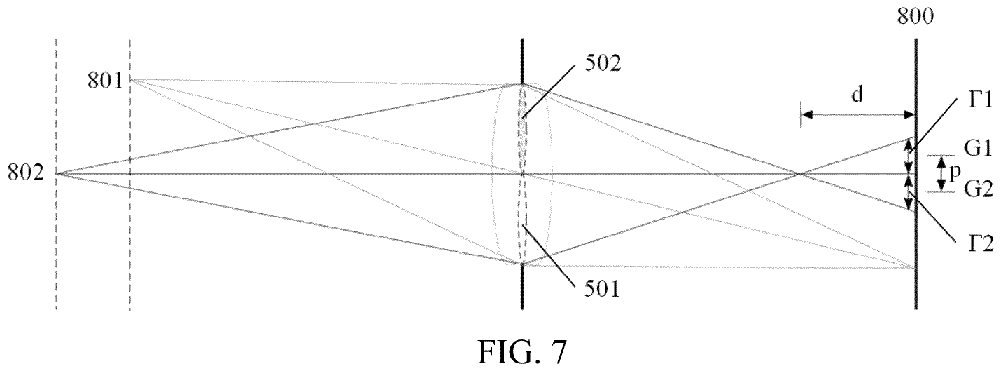

Referring now to FIG. 7, a description will be given of a relationship between a defocus amount and an image shift amount of the first focus detecting signal acquired from the subpixel 301 of the image sensor 104 and the second focus detecting signal acquired from the subpixel 302. FIG. 7 is a relationship diagram between the defocus amount and the image shift amount. In FIG. 7, the image sensor 104 is disposed on an imaging surface 800, and similarly to FIGS. 5 and 6, the exit pupil of the imaging optical system is illustrated divided into two partial pupil regions 501 and 502.

A defocus amount d is defined as a distance from an imaging position of an object to the imaging surface 800 as |d|, a front focus state in which the imaging position is located on the object side of the imaging surface 800 as a negative sign (d<0), and a rear focus state in which the imaging position is located on the opposite side of the object from the imaging surface 800 as a positive sign (d>0). In an in-focus state in which the imaging position of the object is located on the imaging surface 800 (in-focus position), the defocus amount d=0 holds. In FIG. 6, an object 801 in an in-focus state (d=0) and an object 802 in a front focus state (d<0) are illustrated. The front focus state (d<0) and the rear focus state (d>0) are collectively referred to as a defocus state (|d|>0).

In the front focus state (d<0), the light beam from the object 802 that passes through the partial pupil region 501 (or the partial pupil region 502) is condensed once. Thereafter, the light beam spreads to a width Γ1 (Γ2) centered on the center of gravity position G1 (G2) of the light beam, and becomes a blurred image on the imaging surface 800. The blurred image is received by the subpixels 301 (subpixels 302) constituting each pixel disposed on the image sensor 104, and a first focus detecting signal (second focus detecting signal) is generated. Therefore, the first focus detecting signal (second focus detecting signal) is recorded as an object image at the center of gravity position G1 (G2) on the imaging surface 800 in which the object 802 is blurred to a width Γ1 (Γ2). The blur width Γ1 (Γ2) of the object image increases approximately in proportion to the increase in the magnitude |d| of the defocus amount d. Similarly, magnitude |p| of the image shift amount p (=the difference G1−G2 between the center of gravity positions of the light beams) of the object image between the first focus detecting signal and the second focus detecting signal also increases approximately in proportion to the increase in the magnitude |d| of the defocus amount d. This is similarly applicable to the rear focus state (d>0), but the image shift direction of the object image between the first and second focus detecting signals is opposite to that of the front focus state.

Therefore, this embodiment can calculate the defocus amount d based on a conversion coefficient K for converting the previously calculated image shift amount p into the defocus amount d, and the image shift amount p of the object image between the first and second focus detecting signals. The conversion equation from the image shift amount to the defocus amount is as follows:

$$p = d \times K \qquad ( 1 )$$

Thus, in this embodiment, as the magnitude of the defocus amount the first focus detecting signal and the second focus detecting signal or the image signal of the first focus detecting signal and the second focus detecting signal increases, the image shift amount between the first focus detecting signal and the second focus detecting signal increases.

This embodiment performs focusing using the phase-difference detecting method using the relationship between the defocus amount and the image shift amount of the first and second focus detecting signals. In focusing using the phase-difference detecting method, the first focus detecting signal and the second focus detecting signal are shifted relative to each other, the correlation amount that represents the coincidence degree of the signals is calculated, and the image shift amount is detected from the shift amount that improves the correlation (coincidence degree of the signals). Focus detection using the phase-difference detecting method is performed by converting the image shift amount into the defocus amount based on the relationship in which the magnitude of the image shift amount between the first focus detecting signal and the second focus detecting signal increases as the defocus amount of the image signal increases.

### Base Length

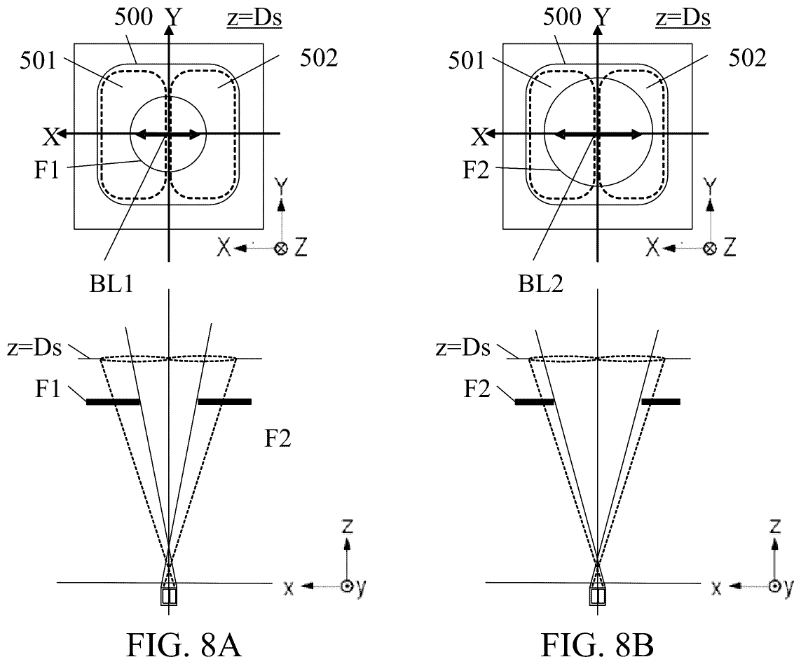

Referring now to FIGS. 8A and 8B, a description will be given of a relationship between an aperture value and a base length. FIGS. 8A and 8B illustrate a relationship between the aperture value and the base length. In this embodiment, a position where the principal ray of each pixel in the image sensor 104 intersects is defined as a pupil distance of the image sensor 104. z=Ds indicates the pupil distance of the image sensor 104. FIG. 8A illustrates the shielding state of the light beam by the imaging optical system for the aperture value F1, and the base length is a length of BL1. FIG. 8B illustrates the shielding state of the light beam by the imaging optical system for the aperture value F2, which is brighter than the aperture value F1, and the base length is a length of BL2. At the same image height, the darker the aperture value is, the more the incident light beam is restricted, and the base length BL1 is shorter than the base length BL2.

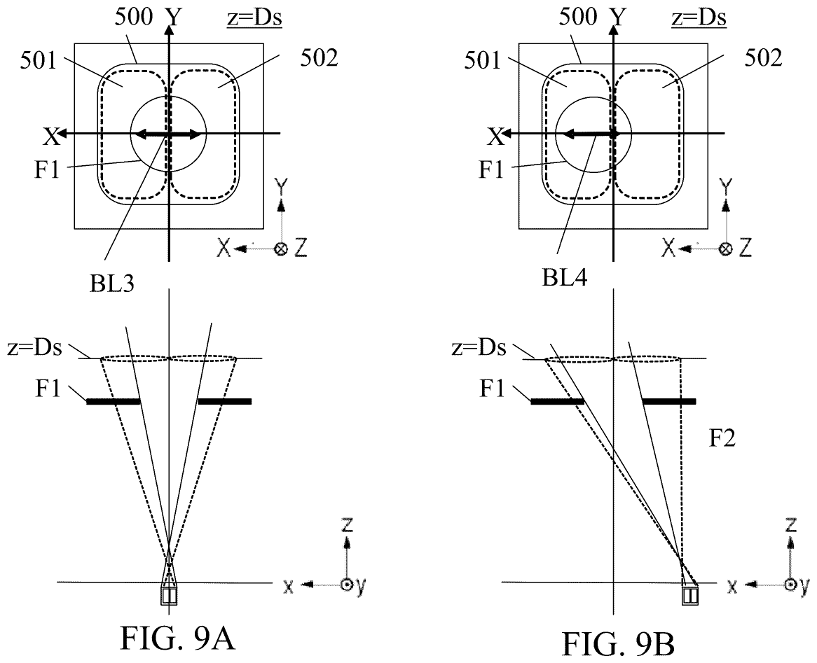

Referring now to FIGS. 9A and 9B, a description will be given of a relationship between a focus-detecting image height and a base length. FIGS. 9A and 9B illustrate a relationship between the focus-detecting image height and the base length. FIG. 9A illustrates a shielding state of a light beam by the imaging optical system in a case where a focus detecting area including image height coordinates is set to central image height ((x_{AF}, y_{AF})=(0, 0)). For the central image height in FIG. 9A, the base length is a length of BL3. FIG. 9B illustrates a shielding state of a light beam by the imaging optical system in a case where the focus detecting area is set to peripheral image height ((x_{AF}, y_{AF})=(−10, 0)). For the peripheral image height in FIG. 9B, the base length is a length of BL4. For the same aperture value, the base length is reduced as the focus detecting position moves from the central image height to the periphery, and the base length BL4 is shorter than the base length BL3.

The base length BL for the pupil distance Ds of the image sensor 104 has a similar relationship to the image shift amount p for the defocus amount d. Therefore, the relationship of the conversion coefficient K to the defocus amount from the base length and the image shift amount can be expressed as in equation (2). That is, as the aperture value becomes darker, or the focus-detecting image height moves farther from the central image height (=as the shorter the base length is), the conversion coefficient from the image shift amount to the defocus amount increases.

$$Ds / BL - d / p = K \qquad ( 2 )$$

### Example of Focus Detecting Processing

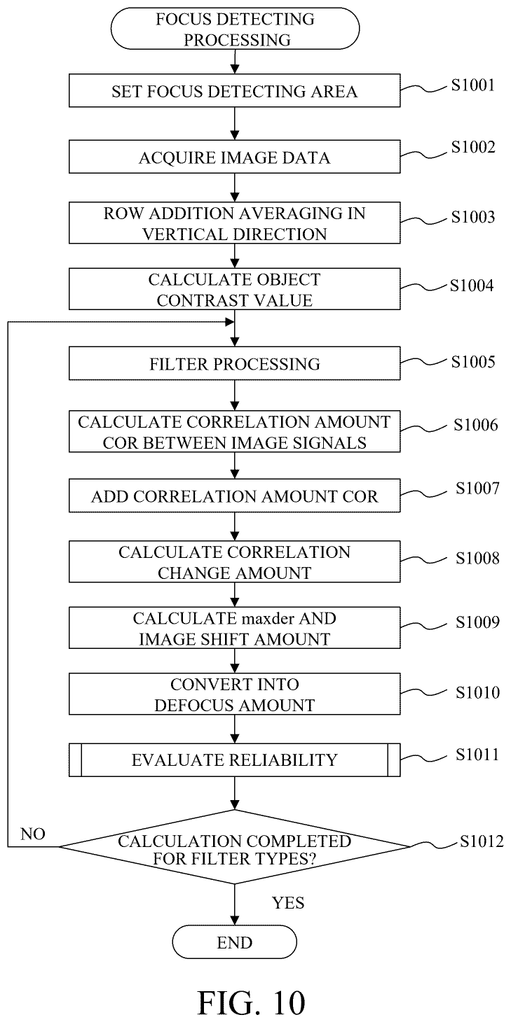

Referring now to FIGS. 10 to 14B, a description will be given of the focus detecting processing in this embodiment. FIG. 10 is a flowchart illustrating an example of the focus detecting processing. Each step in FIG. 10 is mainly executed by each part of the calculation apparatus 102.

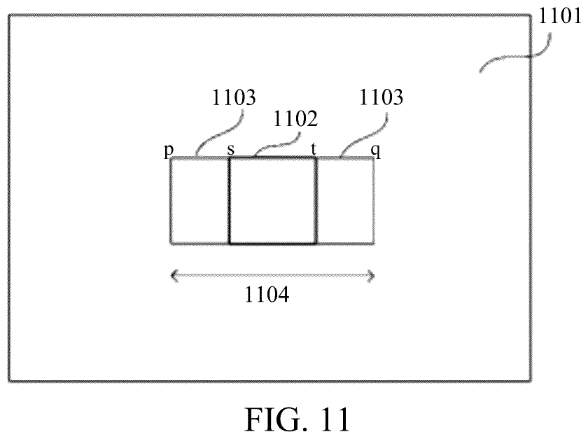

FIG. 11 is a schematic diagram of a focus detecting area 1102. Shift areas 1103 on both sides of the focus detecting area 1102 are areas required for correlation calculation. Therefore, a pixel area 1104, which is a combination of the focus detecting area 1102 and the shift area 1103, is a pixel area required for correlation calculation. In FIG. 11, each of p, q, s, and t represents a coordinate in the horizontal direction (x-axis direction), with p and q respectively indicating the x-coordinates of the start and end points of the pixel area 1104, and s and t respectively indicating the x-coordinates of the start and end points of the focus detecting area 1102.

First, in step S1001, the focus calculator 204 sets a focus detecting area. That is, the focus calculator 204 sets a focus detecting area 1102 of an arbitrary range from the focus detecting areas 1102 arranged two-dimensionally within the imaging screen (captured image) (see FIG. 11).

Next, in step S1002, the focus calculator 204 acquires image data. That is, the focus calculator 204 acquires a pair (two) image signals (image A and image B) for focus detection from the image sensor 104 for the focus detecting area 1102 set in step S1001.

Next, in step S1003, the focus calculator 204 performs row averaging in the vertical direction. That is, the focus calculator 204 performs row averaging in the vertical direction for the pair of image signals acquired in step S1002 to reduce the influence of noise. Here, the vertical direction refers to an extension direction of the vertical signal line (vertical transmission path) of the image sensor 104. In this embodiment, in an attempt to perform calculation processing at high speed, such as in a continuous shooting mode, the number of vertical row averaging is reduced, and in scenes where signal noise is noticeable, such as in dark places, the number of vertical row averaging is increased.

Next, in step S1004, the focus calculator 204 calculates the object contrast value. That is, the focus calculator 204 calculates object contrast value CNT defined by the following equation (3):

$$CNT = ( Peak - Bottom ) / Peak \qquad ( 3 )$$

Here, Peak is a variable indicating a maximum value (maximum output value) of a waveform averaged in the vertical direction, and Bottom is a variable indicating a minimum value (minimum output value) of the waveform averaged in the vertical direction. The focus calculator 204 calculates the object contrast value CNT by dividing a difference between the maximum and minimum values of the waveform averaged in the vertical direction by the maximum value, as expressed by equation (3). The object contrast value CNT is used in evaluating the reliability of the defocus amount.

Next, in step S1005, the focus calculator performs filter processing. That is, the focus calculator 204 performs the filter processing to extract signal components of a predetermined frequency band from the signal averaged in the vertical direction in step S1003. In this embodiment, three types of filters (low frequency band filter, medium frequency band filter, and high frequency band filter) that extract different frequency bands are previously prepared. Which of the defocus amounts calculated using each filter is used is switched according to the blur degree of the object, etc.

In a case where a low frequency band filter is used, the focus detecting performance (performance of calculating the defocus amount) is improved for a highly blurred object with a collapsed edge. In a case where a high frequency band filter is used, the focus detecting performance can be performed with high accuracy near the in-focus point where the edge of the object is sharp (the accuracy of calculating the defocus amount can be improved). This embodiment is not limited to a configuration using three types of filters, and may be configured to use at least one type of filter.

Next, in step S1006, the focus calculator 204 calculates the correlation amount COR between the image signals. That is, the focus calculator 204 calculates the correlation amount COR between a pair (two) of acquired image signals (i.e., signal components in a predetermined frequency band extracted by filter processing). In this embodiment, this calculation will be called “correlation calculation.” The focus calculator 204 performs the correlation calculation for each scanning line after arithmetic averaging in the vertical direction in the focus detecting area.

Next, in step S1007, the focus calculator 204 performs correlation amount COR addition. That is, the focus calculator 204 adds the waveforms of the correlation amount COR in the focus detecting area. Next, in step S1008, the focus calculator 204 calculates the correlation change amount from the correlation amount COR.

Next, in step S1009, the focus calculator 204 calculates the steepness degree (maxder) of the correlation change amount and the image shift amount. That is, the focus calculator 204 calculates a shift amount between the two images (images A and B) based on the correlation change amount calculated in step S1008. The focus calculator 204 also calculates the steepness degree (maxder) of the correlation change amount.

Next, in step S1010, the focus calculator 204 calculates the defocus amount. That is, the focus calculator 204 calculates a defocus amount by multiplying the shift amount between the two images calculated in step S1009 by a predetermined conversion coefficient. The conversion coefficient that is used at this time is a value determined according to the aperture value, the exit pupil distance of the imaging optical system, individual information about the image sensor 104, and the coordinates for setting the focus detecting area 1102, and is previously stored in a ROM (not illustrated). The focus calculator 204 evaluates a focus shift amount using the same index even if the aperture value is different by normalizing the calculated defocus amount by dividing it by the aperture value and the permissible circle of confusion 8.

Next, in step S1011, the focus calculator 204 evaluates reliability. That is, the focus calculator 204 evaluates the reliability of the defocus amount calculated in step S1010 based on maxder (steepness degree of the correlation change amount) calculated in step S1009. Details of the reliability evaluation processing in step S1011 will be described later.

Next, in step S1012, the focus calculator 204 determines whether or not calculations have been performed for the number of filter types. That is, the focus calculator 204 determines whether or not the processing in steps S1005 to S1011 have been performed for all of the three types of filters (low-frequency band filter, mid-frequency (intermediate frequency) band filter, and high-frequency band filter) that have been previously prepared. In a case where there are any filters that have not yet been executed (if “NO”), the flow returns to step S1005, and steps S1005 to S1011 are executed for the filters that have not yet been executed. On the other hand, if execution has been completed for all types of filters (if “YES”), the focus detecting processing of this flow ends.

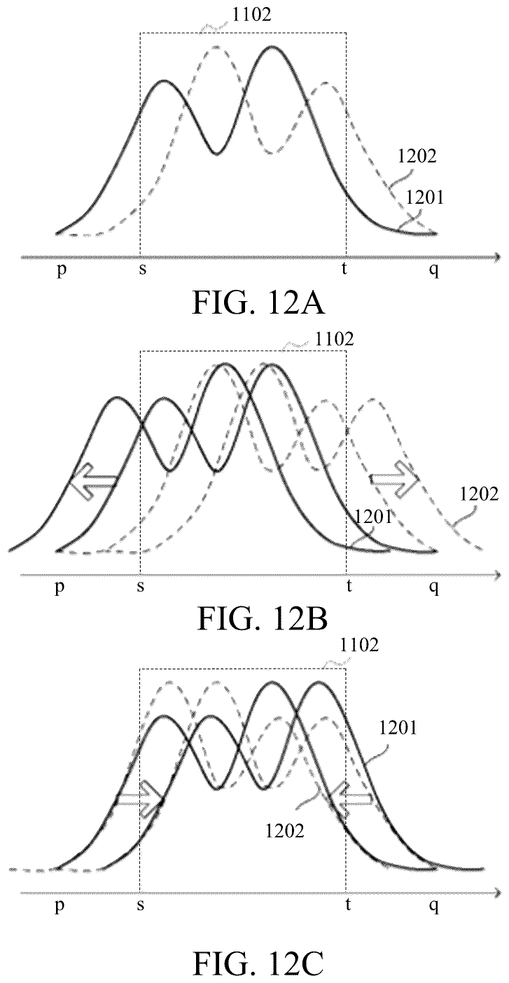

Referring now to FIGS. 11 to 14B, a detailed description will be given of the focus detecting processing. FIGS. 12A, 12B and 12C are schematic diagrams illustrating an example of a pair of image signals obtained from the focus detecting area 1102 illustrated in FIG. 11. FIGS. 12A, 12B and 12C illustrate an example of a pair of image signals for focus detection that have been subjected to filter processing. One image signal A1201 is illustrated by a solid line, and the other image signal B1202 is illustrated by a broken line. FIG. 12A illustrates image signals A1201 and B1202 before it is shifted, and FIGS. 12B and 12C illustrate the image signals A1201 and B1202 after they are shifted in the positive and negative directions from the state of FIG. 12A, respectively. In calculating a correlation amount between the pair of image signals A1201 and B1202, both image signals A1201 and B1202 are shifted by one bit at a time in the arrow directions.

The correlation amount is calculated as follows. First, as illustrated in FIGS. 12B and 12C, each of the image signals A1201 and B1202 is shifted by an arbitrary constant number of bits to calculate the sum of the absolute values of the differences between image signals A1201 and B1202. In this embodiment, the bit width to be shifted and the total shift amount are switched according to the filter to be used. In using a low-frequency band filter, the total shift amount is larger than that in using a high-frequency band filter for the focus detection of a significantly blurred object, and the bit width to be shifted is increased to reduce the calculation time. On the other hand, in using a high-frequency band filter, the bit width to be shifted is smaller than that in using a low-frequency band filter in order to perform the focus detection with high accuracy, and the total shift amount reduced in order to reduce the calculation time.

The correlation amount COR can be calculated by the following equation (4):

$$COR [ i ] = {\sum }_{k = x}^{y} \vert A [ K + i ] - B [ K - i ] \vert \qquad ( 4 )$$

where i is the total shift amount, p−s is a minimum shift amount, q−t is a maximum shift amount, x is the starting coordinate of the focus detecting area 1102, and y is the end coordinate of the focus detecting area 1102. (p−s)<i<(q−t).

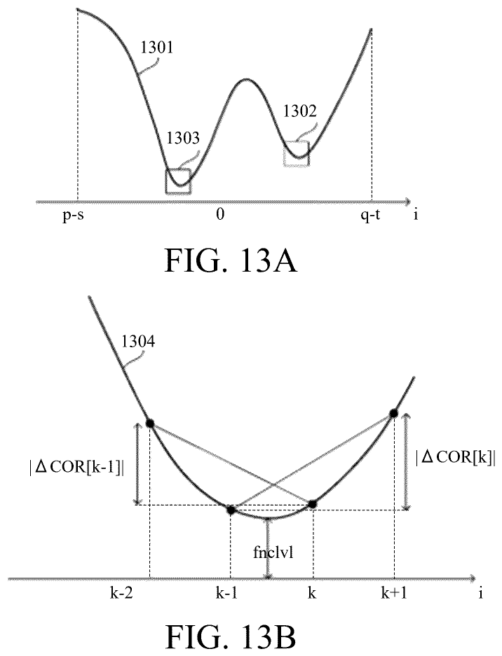

FIG. 13A illustrates an example of the relationship between the shift amount and the correlation amount COR (correlation amount waveform). FIG. 13B is an enlarged view of an extreme value vicinity 1303 in FIG. 13A, and a curve indicated by reference numeral 1304 is a part of the correlation amount waveform 1301 of the extreme value vicinity 1303. The horizontal axis indicates a shift amount, and a vertical axis indicates the correlation amount COR. As illustrated in FIG. 13A, the correlation amount waveform 1301 changes according to the shift amount. Among the plurality of extreme value vicinities 1302 and 1303 included in the correlation amount waveform 1301, the two-image coincidence degree, which is the coincidence degree between the pair of image signals A and B, is highest at the shift amount corresponding to the smallest extreme value vicinity 1303.

The correlation change amount is calculated as follows. The focus calculator 204 calculates a correlation change amount as a difference between the correlation amount at every other shift in the correlation amount waveform 1301 illustrated in FIG. 13A. Where i is a shift amount, p−s is a minimum shift amount, and q−t is a maximum shift amount, the correlation change amount ΔCOR can be calculated by the following equation (5): {(p−s+1)<i<(q−t−1)}.

$$Δ COR [ i ] = COR [ i - 1 ] - COR [ i + 1 ] \qquad ( 5 )$$

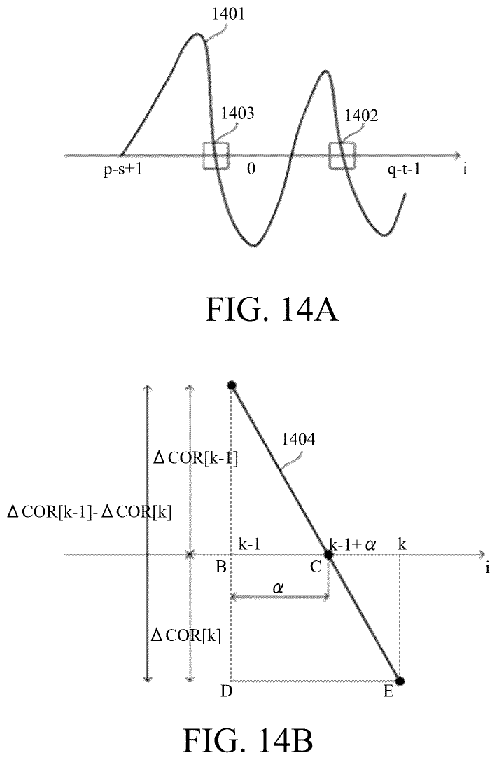

FIG. 14A illustrates an example of the relationship between the shift amount and the correlation change amount ΔCOR (correlation change amount waveform). The horizontal axis indicates the shift amount, and the vertical axis indicates the correlation change amount ΔCOR. The correlation change amount 1401 changes with the shift amount. In FIG. 14A, the correlation change amount 1401 goes from positive to negative at portions indicated by reference numerals 1402 and 1403. The state in which the correlation change amount is 0 is called a zero crossing, and the coincidence degree of between the pair of image signals A and B is highest. Therefore, the shift amount that gives the zero crossing is a two-image shift amount.

FIG. 14B is an enlarged view of the portion indicated by reference numeral 1402 in FIG. 14A. A line indicated by reference numeral 1404 is a portion of the correlation change amount 1401. A method for calculating two-image shift amount PRD will now be described with reference to FIG. 14B.

A shift amount (k−1+α) that gives the zero crossing is divided into an integer part β (=k−1) and a decimal part α. The decimal part α can be calculated from the similarity relationship between triangles ABC and ADE in FIG. 14B using the following equation (6):

$$AB : AD = BC : DE Δ COR [ K - 1 ] = Δ COR [ k - 1 ] - Δ COR [ k ] = α : k - ( k - 1 ) α = \frac{Δ CO R [ K - 1 ]}{Δ COR [ K - 1 ] - Δ COR [ K ]} \qquad ( 6 )$$

The integer part β can be calculated from FIG. 14B using the following equation (7):

$$β = K - 1 \qquad ( 7 )$$

The second image shift amount PRD can be calculated from the sum of α and β.

As illustrated in FIG. 14A, in a case where there are a plurality of zero crossings in the correlation change amount ΔCOR, the zero crossing with the largest maxder nearby is set as the first zero crossing. maxder is an index that indicates the ease of focus detection, and the larger the value is, the easier it is to perform focus detection with high accuracy. maxder can be calculated using the following equation (8):

$$max der = \vert Δ COR [ K - 1 ] \vert + \vert Δ COR [ K ] \vert \qquad ( 8 )$$

where ΔCOR [k−1] is a correlation change amount between shift amounts k−2 and k, and ΔCOR [k] is a correlation change amount between shift amounts k−1 and k+1.

Thus, in a case where there are a plurality of zero crossings in the correlation change amount, this embodiment determines the first zero crossing based on maxder. The shift amount that gives this first zero crossing is set as an image shift amount.

### AF Reliability

AF reliability will now be explained. Noise is superimposed on a signal read from the image sensor 104. Since focus detection is performed using the signal superimposed with noise, a detection variance Δp of the image shift amount occurs. Then, by multiplying the detection variance Δp by the conversion coefficient K from the image shift amount to the defocus amount, a detection variance Δd of the defocus amount is obtained. The following equation (9) illustrates this relationship:

$$Δ d = Δ p \times K \qquad ( 9 )$$

In this embodiment, the AF reliability is defined as a standard deviation of the defocus amount, which is a value based on the variation in the focus detection amount. The larger the standard deviation of the defocus amount is, the lower the AF reliability is. The standard deviation of the defocus amount is determined according to the object condition (contrast) and the imaging condition of the camera body 101 (base length, accumulation time, frame rate, ISO speed). The lower the contrast of the object, the shorter the accumulation time is, the shorter the frame rate is, and the higher the ISO speed is, the lower the S/N ratio of the focus detecting signal is, and the larger the detection variation of the image shift amount is, so the larger the standard deviation of the defocus amount is. In a case where the aperture value (focus detecting signal) is dark or the focus detecting position is located at the peripheral image height, the shorter the base length is, the larger the conversion coefficient for converting the image shift amount into the defocus amount is, and the larger the standard deviation of the defocus amount is.

In this embodiment, a permissible value of the standard deviation of the defocus amount that enables AF is defined as a threshold (value) of the AF reliability. Only in a case where the AF reliability is equal to or greater than a predetermined value, the AF reliability is deemed sufficient, and control is made to perform the AF.

### AF Reliability Evaluating Method

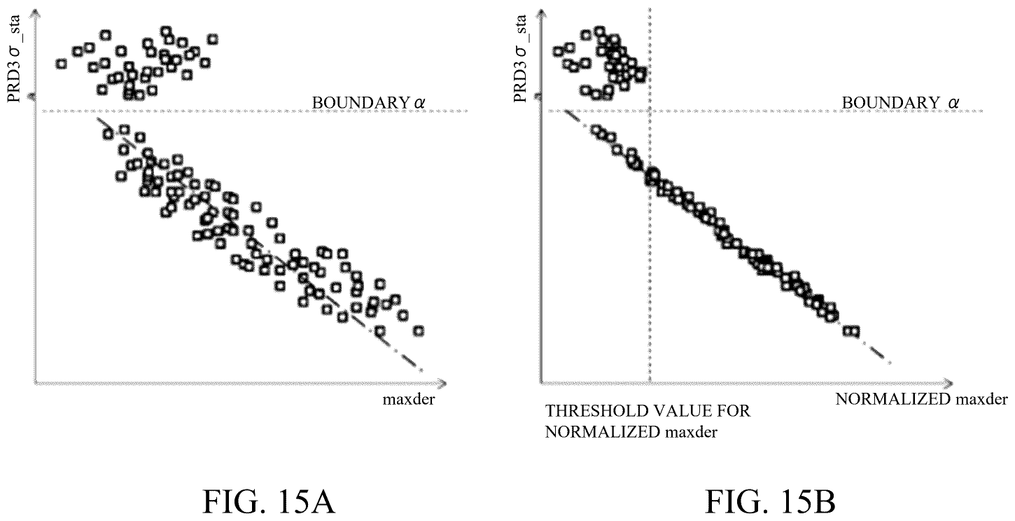

Normally, the standard deviation of the defocus amount cannot be directly calculated from the focus detecting signal of one frame. For example, Japanese Patent Laid-Open No. 2018-45101 discloses a method for estimating the standard deviation of the defocus amount from maxder. FIGS. 15A and 15B explain a relationship between maxder and the standard deviation of the image shift amount in a case where an object and a focus detection setting (contrast, ISO speed, and the number of additions of the focus detecting signal in the vertical direction, etc.) are set to the same conditions and the focus detection is performed N times. In FIGS. 15A and 15B, the horizontal axis indicates maxder, and the vertical axis indicates the standard deviation of the image shift amount.

The standard deviation of the image shift amount can be estimated from maxder by utilizing the correlation relationship in the area smaller than the boundary a. However, the correlation relationship between the standard deviation of maxder and image shift amount differs slightly according to the object and focus detecting setting, and the estimation accuracy decreases. Accordingly, by normalizing maxder according to the object and focus detecting setting, the correlation between maxder and the standard deviation of the image shift amount approaches −1, and the estimation accuracy is improved.

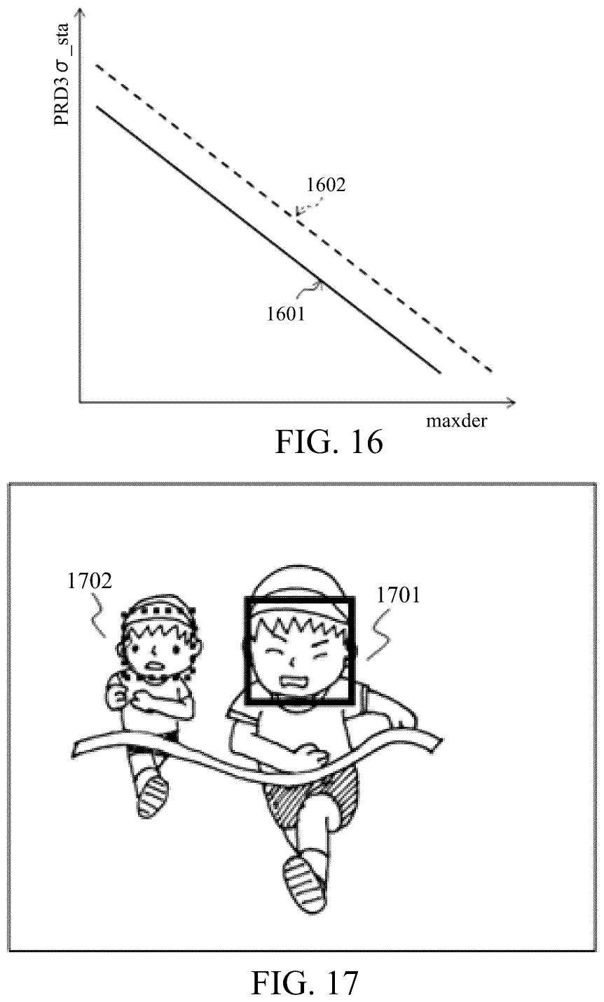

For example, FIG. 16 illustrates a relationship between the standard deviation of maxder and the image shift amount at low and high ISO speeds. In the case of low ISO speed, a relationship is represented by a solid line 1601, and in the case of high ISO speed, a relationship is represented by a broken line 1602. To fill this difference, maxder is normalized using the following equation (10) using coefficient again, which is determined according to the ISO speed.

$${norm\_maxder}_{g a i n} = maxder \times {a}_{g a i n} \qquad ( 10 )$$

However, normalization of maxder may be performed according to not only the ISO speed, but also another object condition (contrast) and focus detecting condition (such as the number of vertical additions). The estimated value Def3σ_est of the standard deviation of the defocus amount is obtained, for example, by the following equation (11). Here, maxder, norm_maxder_{gain} that normalizes maxder, approximate equation coefficients a and b of the correlation relationship between norm_maxder and the standard deviation of the image shift amount previously measured, and conversion coefficient K from an image shift amount to a defocus amount.

$$Def 3 σ\_est = a \times ( max der \times {norm\_maxder}_{gain} ) \hat{} b \times K \qquad ( 11 )$$

From equation (11), AF reliability can be predicted in an exposure different from the exposure set during focus detection. For example, AF reliability is predicted under conditions where the accumulation time or frame rate is one step shorter, or the aperture stop 122 is one step darker and a focus detecting signal is one step darker (signal amount becomes ½). At this time, by utilizing the fact that maxder is proportional to the signal amount, a maxder value obtained by dividing the maxder value during focus detection by 2 may be used. To predict AF reliability in a case where the ISO speed is different, a normalization coefficient of maxder corresponding to the corresponding ISO speed may be used. In predicting AF reliability in a case where the base length is different due to a difference in aperture value or focus-detecting image height, a conversion coefficient of the defocus amount may be used from the image shift amount corresponding to the aperture value or focus-detecting image height.

### Depth Control

Referring now to FIG. 17, a method of controlling the aperture stop 122 so that a plurality of detected objects or object parts fall within the same depth will be described. FIG. 17 illustrates a state in which a primary object (first object) 1701 and a secondary object (second object) 1702 are detected. First, the defocus amount is obtained as the depth information about each object. In the example of FIG. 17, defocus amount Def1 of the primary object 1701 and defocus amount Def2 of the secondary object 1702 are obtained.

Next, a difference in the defocus amount is calculated as a depth difference between these objects, and an aperture value F is calculated so that the depth difference falls within a predetermined depth range. For example, the predetermined depth range is set to +F8, which is the product of the aperture value F and a permissible circle of confusion diameter δ. In this case, the aperture value F can be calculated to keep the primary object 1701 and the secondary object 1702 within the range of +1F8 so as to satisfy the following equation (12).

$$\vert Def 1 - Def 2 \vert = 1 F δ \qquad ( 12 )$$

In this embodiment, there are two objects as an example, but the number of objects is not limited. For three or more objects, the aperture value F may be determined so that the objects with the maximum and minimum defocus amounts fall within the same depth.

### Reduction in AF Reliability During Depth Control

By narrowing the aperture stop 122 using the depth control function, the signal amount decreases, and the S/N ratio of the focus detecting signal decreases. Even if the ISO speed is increased to achieve proper exposure, noise increases, and the S/N ratio of the focus detecting signal decreases. The base length is reduced, so the conversion coefficient for converting the image shift amount to the defocus amount increases. As a result, the standard deviation of the defocus amount increases, and depending on the contrast of the object, may exceed the threshold value of the AF reliability, causing AF inability.

### Avoiding AF Inability in Depth Control

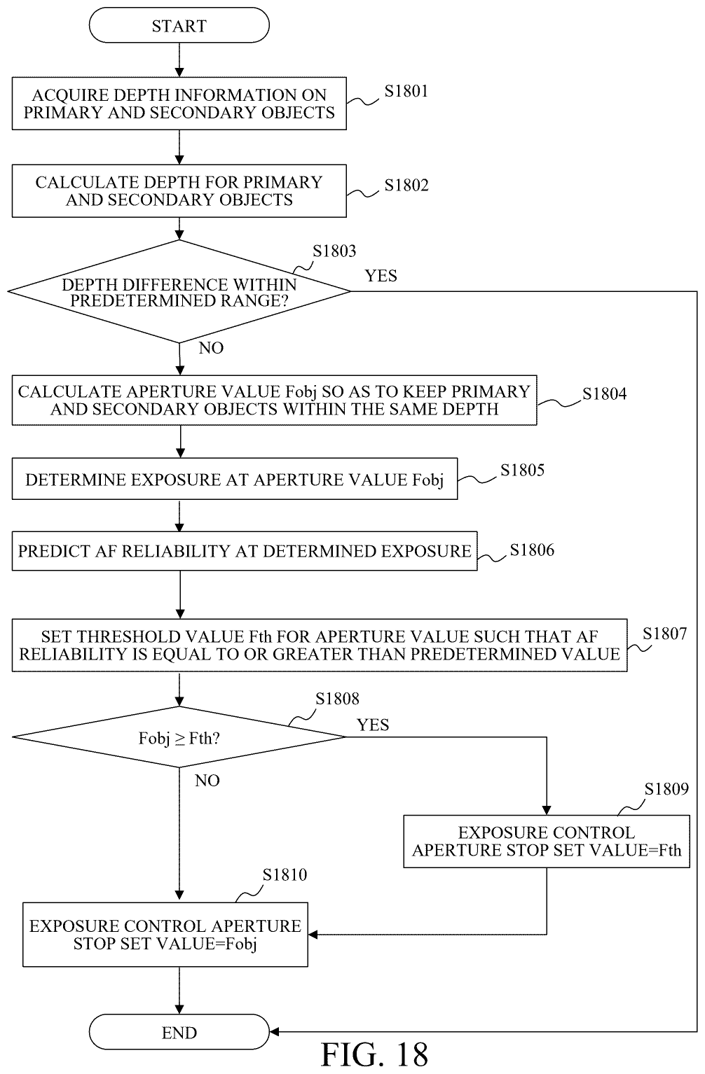

Referring now to FIG. 18, a description will be given of a method of performing aperture stop control within a range of aperture values that does not exceed the AF reliability threshold after depth control in order to avoid AF inability in a case where the aperture stop 122 is narrowed by the depth control function. FIG. 18 is a flowchart illustrating the depth control method according to this embodiment. Each step in FIG. 18 is mainly executed by each unit of the calculation apparatus 102, such as the control unit 201.

First, in step S1801, the control unit 201 acquires a defocus amount of each object as depth information about primary and secondary objects. Next, in step S1802, the control unit 201 calculates a difference in the defocus amount between the objects as the depth difference between the primary and secondary objects.

Next, in step S1803, the control unit 201 determines whether the depth difference calculated in step S1802 falls within a predetermined range. In a case where it is determined that the depth difference falls within the predetermined range, this flow ends. On the other hand, in a case where it is determined that the depth difference is outside the predetermined range, the flow proceeds to step S1804.

In step S1804, the control unit 201 calculates a target aperture value Fobj for keeping the primary and secondary objects within the same depth. Next, in step S1805, the focus calculator 204 determines proper exposure for each aperture value from the current aperture value Fpre to the target aperture value Fobj. Next, in step S1806, the control unit 201 predicts the standard deviation of the defocus amount at each aperture value (AF reliability at the determined exposure (reliability of the focus detection amount)). As a prediction method, the above method of estimating the standard deviation of the defocus amount from maxder is used. Next, in step S1807, the control unit 201 sets a threshold value Fth for the aperture value at which the standard deviation of the defocus amount is equal to or less than a predetermined value (AF reliability is equal to or greater than a predetermined value).

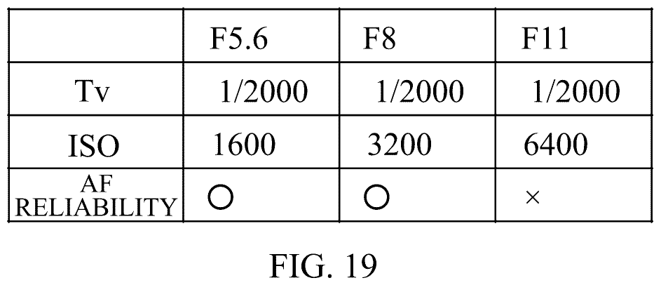

FIG. 19 illustrates an example of the correspondence between AF reliability and exposure from the current aperture value Fpre to the target aperture value Fobj. In the AF reliability column, a circle mark is displayed in a case where the standard deviation of the defocus amount is equal to or less than a predetermined value, and a cross mark is displayed in a case where the standard deviation is greater than the predetermined value. In the example of FIG. 19, the AF reliability is labelled as the circle mark and AF is possible up to “F8”, so the aperture value threshold Fth is set to “F8”.

Next, in step S1808, the control unit 201 determines whether the target aperture value Fobj is equal to or greater than the aperture value threshold Fth. In a case where the target aperture value Fobj is equal to or greater than the aperture value threshold Fth (Fobj≥Fth), the flow proceeds to step S1809. In step S1809, the control unit 201 controls the exposure so that the exposure becomes the aperture value threshold Fth determined in step S1807. On the other hand, in a case where the target aperture value Fobj is less than the aperture value threshold value Fth (Fobj<Fth) in step S1808, the flow proceeds to step S1810. In step S1810, the control unit 201 performs exposure control so that the exposure is at the target aperture value Fobj determined in step S1805.

As described above, the control unit 201 determines the aperture value so that a plurality of objects or a plurality of parts fall within a predetermined depth within a range that satisfies a predetermined condition that enables focus detection (AF processing). For example, the control unit 201 changes the aperture value depending on whether or not the predetermined condition is satisfied (S1809, S1810). For example, in acquiring a focus detecting signal, the control unit 201 sets the aperture stop 122 to the aperture value to control the exposure. For example, the condition that enables the focus detection is that an evaluation value regarding the reliability of the focus detection amount (AF reliability) falls within a predetermined range (S1808). For example, the evaluation value is a value regarding the variation in the focus detection amount. For example, the variation in the focus detection amount is the standard deviation of the defocus amount. For example, the control unit 201 estimates an aperture value that satisfies a predetermined condition before controlling the aperture stop 122.

The evaluation value may be determined according to at least one of the base length, the focus detecting frame position, the object contrast value, the accumulation time, the frame rate, and the ISO speed. For example, the control unit 201 controls the aperture stop 122 so that the focus detecting signal becomes darker as the base length increases. For example, the control unit 201 controls the aperture stop 122 so that the focus detecting signal becomes darker as the focus detection frame position approaches the center. For example, the control unit 201 controls the aperture stop 122 so that the focus detecting signal becomes darker as the object contrast value increases. For example, the control unit 201 controls the aperture stop 122 so that the focus detecting signal becomes darker as the accumulation time increases. For example, the control unit 201 controls the aperture stop 122 so that the focus detecting signal becomes darker as the frame rate increases. For example, the control unit 201 controls the aperture stop 122 so that the focus detecting signal becomes darker as the ISO speed is reduced.

In the depth priority control, this embodiment controls the aperture stop so that the AF reliability after depth control is equal to or lower than a predetermined threshold value according to the object condition and the imaging condition of the camera body 101. Therefore, this embodiment can avoid an AF inability state.

### Second Embodiment

A description will now be given of a second embodiment according to the present disclosure. This embodiment sets the accumulation time according to an image-plane moving speed of an object.

In achieving proper exposure in a case where the aperture stop 122 is narrowed down in depth priority control, the accumulation time may be increased instead of increasing the ISO speed for noise suppression. However, depending on the image-plane moving speed of the object, the longer accumulation time causes object blur to increase.

An example of an imaging scene in which the image-plane moving speed of the object changes includes a scene in which the object approaches the camera in the optical axis direction. The image-plane moving speed is faster in a case where the object is closer to the close distance side than the infinity side. Even when the zoom magnification is changed, the image-plane moving speed of the object changes. As the zoom magnification is more quickly changed, the image-plane moving speed of the object increases.

In such a scene, if the accumulation time is set uniformly, the following problem occurs. That is, in a case where the image-plane moving speed is reduced, the ISO speed cannot be reduced even though there is room to increase the accumulation time, so noise suppression may become insufficient. On the other hand, in a case where the image-plane moving speed is fast, object blur suppression may be insufficient.

Thus, this embodiment will discuss a control method in which the accumulation time is set according to the image-plane moving speed of the object, and properly performs object blur suppression and noise suppression according to the imaging scene. An upper limit on the long second side of the accumulation time is set according to the image-plane moving speed of the object. Then, depth control is performed within an aperture value range that do not exceed the AF reliability threshold under the upper limit of the accumulation time.

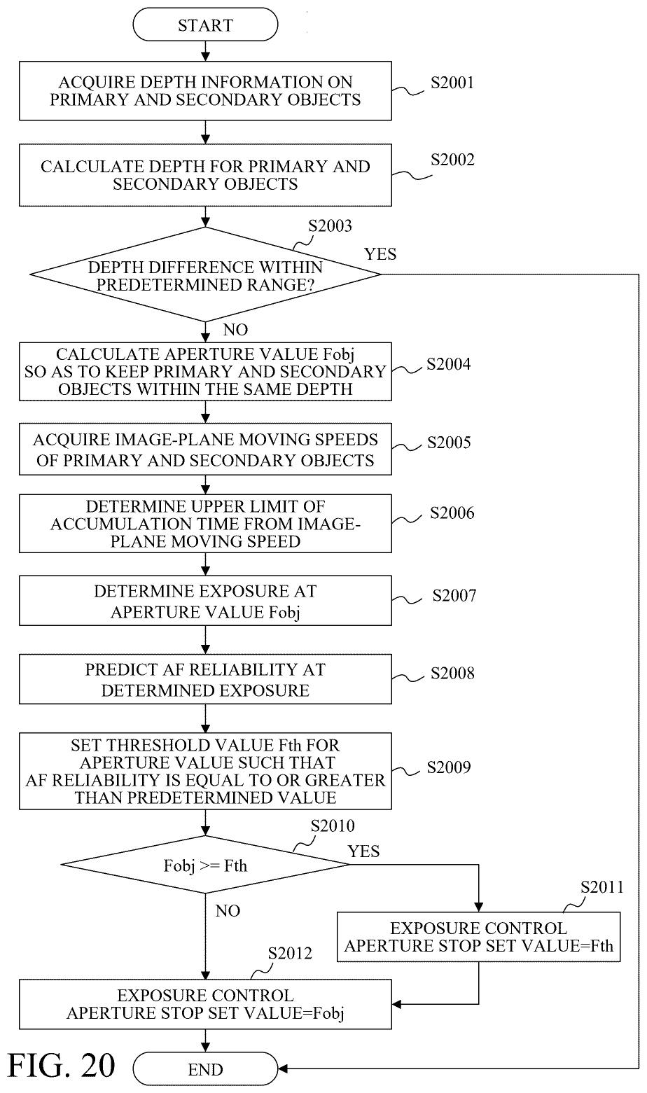

Referring now to FIG. 20, depth control method according to this embodiment will be described. FIG. 20 is a flowchart illustrating the depth control method in this embodiment. Each step in FIG. 20 is mainly executed by each unit such as the control unit 201 of the calculation apparatus 102. FIG. 20 is different from FIG. 18 in that steps S2005 and S2006 are added. Steps S2001 to S2004 and S2007 to S2012 in FIG. 20 correspond to steps S1801 to S1810 in FIG. 18, and a description thereof will be omitted.

In step S2005, the control unit 201 acquires the image-plane moving speeds of the primary and secondary objects. The image-plane moving speeds can be calculated as a difference in defocus amount per unit time. The image-plane moving speed during zooming may be calculated from a rotation speed of a zoom ring.

In step S2006, the control unit 201 determines the upper limit of the accumulation time based on the image-plane moving speed acquired in step S2005. The upper limit of the accumulation time for each image-plane moving speed may be previously stored in table format, and the table may be referenced from the acquired image-plane moving speed. This embodiment is not limited to determining an upper limit for the accumulation time as long as the range of the accumulation time can be determined.

As described above, the control unit 201 changes the range of the accumulation time according to the image-plane moving speed of the object, and determines an aperture value that satisfies the predetermined condition within the range of the accumulation time. In this manner, this embodiment can suppress noise and object blur according to the imaging scene by setting the accumulation time according to the image-plane moving speed of the object. Therefore, this embodiment can widen the aperture value range that can be set in the depth priority control.

Each embodiment determines the aperture value based on the object condition and the imaging condition of the image pickup apparatus in the depth control function that controls the aperture stop to control the imaging depth. Therefore, each embodiment can provide an image pickup apparatus, its control method, and a storage medium that can suppress AF failure caused by variation in focus detection amount after the aperture stop is narrowed.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an image pickup apparatus that can properly perform AF processing during depth control.

This application claims priority to Japanese Patent Application No. 2024-075326, which was filed on May 7, 2024, and which is hereby incorporated by reference herein in its entirety.

What is claimed is:

1. An image pickup apparatus comprising:
an image sensor; and
a processor configured to:
acquire a focus detection amount based on a signal acquired from the image sensor,
control an aperture stop based on the focus detection amount, and
determine an aperture value such that a plurality of objects or a plurality of parts fall within a predetermined depth within a range that satisfies a predetermined condition that enables focus detection.

2. The image pickup apparatus according to claim 1, wherein the processor is configured to change the aperture value according to whether the predetermined condition is satisfied.

3. The image pickup apparatus according to claim 1, wherein the processor is configured to control exposure by setting the aperture stop to the aperture value in acquiring the signal.

4. The image pickup apparatus according to claim 1, wherein the predetermined condition is that an evaluation value regarding reliability of the focus detection amount falls within a predetermined range.

5. The image pickup apparatus according to claim 4, wherein the evaluation value is a value regarding variation of the focus detection amount.

6. The image pickup apparatus according to claim 5, wherein the variation in the focus detection amount is a standard deviation of a defocus amount.

7. The image pickup apparatus according to claim 4, wherein the evaluation value is determined according to at least one of a base length, a focus detecting frame position, an object contrast value, an accumulation time, a frame rate, or an ISO speed.

8. The image pickup apparatus according to claim 7, wherein the processor is configured to control the aperture stop such that the signal becomes darker as the base length increases.

9. The image pickup apparatus according to claim 7, wherein the processor is configured to control the aperture stop such that the signal becomes darker as the focus detecting frame position approaches a center.

10. The image pickup apparatus according to claim 7, wherein the processor is configured to control the aperture stop such that the signal becomes darker as the object contrast value increases.

11. The image pickup apparatus according to claim 7, wherein the processor is configured to control the aperture stop such that the signal becomes darker as the accumulation time increases.

12. The image pickup apparatus according to claim 7, wherein the processor is configured to control the aperture stop such that the signal becomes darker as the frame rate increases.

13. The image pickup apparatus according to claim 7, wherein the processor is configured to control the aperture stop such that the signal becomes darker as the ISO speed is reduced.

14. The image pickup apparatus according to claim 1, wherein the processor is configured to estimate the aperture value that satisfies the predetermined condition before controlling the aperture stop.

15. The image pickup apparatus according to claim 1, wherein the processor is configured to:
change a range of accumulation time according to an image-plane moving speed of each object, and
determine the aperture value that satisfies the predetermined condition within the range of the accumulation time.

16. The image pickup apparatus according to claim 1, wherein the image sensor has a plurality of focus detecting pixels configured to receive light beams that each pass through different partial pupil regions of an imaging optical system that includes the aperture stop, and
wherein the signal is a pair of signals acquired from the plurality of focus detecting pixels.

17. A control method for an image pickup apparatus comprising:
acquiring a focus detection amount based on a signal acquired from an image sensor;
controlling an aperture stop based on the focus detection amount, and
determining an aperture value such that a plurality of objects or a plurality of parts fall within a predetermined depth within a range that satisfies a predetermined condition that enables focus detection.

18. A non-transitory computer-readable storage medium storing a program that causes a computer to execute the control method defined in claim 17.
